(19) United States
(12) Patent Application Publication
(10) Pub. No.: US 2016/0167007 A9
(43) Pub. Date: Jun. 16, 2016

(54) INTER-BED MIXING IN FIXED BED REACTORS

(71) Applicant: ExxonMobil Research and Engineering Company, Annandale, NJ (US)

(72) Inventors: Hans Georg KORSTEN, Falls Church, VA (US); Benjamin Santiago UMANSKY, Fairfax, VA (US); Anastasios Ioannis SKOULIDAS, Calgary (CA); Antonio O. RAMOS, Houston, TX (US); Keith WILSON, Weybridge (GB)

(73) Assignee: ExxonMobil Research and Engineering Company, Annandale, NJ (US)

(21) Appl. No.: 14/541,366

(22) Filed: Nov. 14, 2014

Related U.S. Application Data
(60) Provisional application No. 61/911,144, filed on Dec. 3, 2013.

(51) Int. Cl. B01J 19/00

(52) U.S. Cl. CPC B01J 19/0066; B01J 2219/00761

(57) ABSTRACT

A stator-type mixing device is used as a mixing device between fixed catalyst beds in a reactor. The mixing device includes a plurality of blades or surfaces arranged around a central hub. The blades are arranged at an angle relative to vertical so that a fluid cannot pass vertically through the mixing device without contacting at least one blade or surface. The blades or surfaces allow the stator-type mixing device to span the full cross-sectional surface area of the reactor, so that concentration of liquids in a localized portion of the reactor cross-sectional area is reduced or minimized. For reactors where at least part of the process fluid is a liquid under reaction conditions, a distributor tray can be included below the stator-type mixing device.

### CROSS-REFERENCE TO RELATED APPLICATIONS

This application claims priority to U.S. Provisional Application Ser. No. 61/911,144 filed Dec. 3, 2013, herein incorporated by reference in its entirety.

### FIELD OF THE INVENTION

Systems and methods are provided for catalytic processing of feedstocks in fixed bed reactors.

### BACKGROUND

Catalytic fixed bed reactors have been utilized for many decades in the petroleum and petrochemical refining industry (i.e., the “industry”) for upgrading raw or intermediate petroleum-based feedstocks into more valuable fuel and chemical products and base stocks. Chemicals reactors have diameters usually not more than 10 ft, typically 2 to 6 ft. Refining hydroprocessing reactors can have larger diameters, such as up to 24 ft or larger, with 8 to 18 ft being more typical.

Fixed bed reactors are among the most commonly used type of reactor in the refining and chemical industry. For example, many fixed bed reactors are used for highly exothermic reactions such as hydroprocessing or hydrocracking. For such applications, multi-bed reactors are usually required in order to limit the temperature increase within each bed, to avoid thermodynamic equilibrium limitations, or to prevent maldistribution problems. For highly exothermic reactions, a quench gas, liquid, or a combination of both is usually injected between the catalyst beds in order to reduce the inlet temperature to the next catalyst bed. To achieve homogeneous temperature and concentration profiles, and to enhance mass transport between the process fluids and the quench fluids, the process and quench fluids are typically passed through mixing internals before entering the next catalyst bed. Even without injection of a quench fluid, the installation of mixing internals is advantageous for achieving homogeneous temperature and concentration profiles, because significant non-uniform profiles are often generated within catalyst beds. Without mixing between the beds, temperature variations and/or localized concentrations of fluid flow can be passed on into the next bed. This can lead to amplification of any temperature variations, potentially leading to hot spots and ultimately reactor runaway.

U.S. Pat. No. 5,635,145 describes a multi-bed downflow reactor. Between catalyst beds, a liquid collection tray is used to collect liquid that exits an upper catalyst bed. The collected liquid is passed through guiding channels to a central part of the mixing zone. A subsequent distribution tray is then used to redistribute the liquid prior to entering the next catalyst bed.

U.S. Pat. No. 7,601,310 describes a distributor system for downflow reactors. Between catalyst beds, a liquid collection tray is used to collect liquid that exits an upper catalyst bed. The collected liquid is passed through spillways that are designed to impart a swirling motion to the liquid passing through the spillways. The liquid is then passed into a mixing chamber. The liquid exits the mixing chamber and drops onto an impingement plate that radially distributes the liquid. A subsequent distribution tray is then used to redistribute the liquid prior to entering the next catalyst bed.

### SUMMARY

In an aspect, a reactor for exposing a reaction fluid to catalyst in a plurality of fixed catalyst beds is provided. The reactor includes at least one reactor inlet and at least one reactor outlet; a first catalyst bed and a second catalyst bed, the second catalyst bed being downstream from the first catalyst bed during operation of the reactor; and a mixing device located between the first catalyst bed and the second catalyst bed, the mixing device comprising a plurality blades attached to a central hub, the blades being oriented at an angle of from about 15° to about 75° relative to a reference axis of the mixing device, a cross sectional area of the mixing device being at least about 85% of a cross sectional area of the reactor, wherein a ratio of a minimum path length for the mixing device to the height of the mixing device is about 4.0:1 or less.

In another aspect, a reactor for exposing a reaction fluid to catalyst in a fixed catalyst bed is provided. The reactor includes at least one reactor inlet and at least one reactor outlet; a catalyst bed; and a mixing device located upstream from the catalyst bed, the mixing device comprising a plurality blades attached to a central hub, the blades being oriented at an angle of from about 15° to about 75° relative to a reference axis of the mixing device, a cross sectional area of the mixing device being at least about 85% of a cross sectional area of the reactor, wherein a height of the mixing device is about 0.25 times to about 1.0 times a height of a blade, such as 0.4 times the height of a blade.

In still another aspect, a reactor for exposing a reaction fluid to catalyst in a plurality of fixed catalyst beds is provided. The reactor includes at least one reactor inlet and at least one reactor outlet; a first catalyst bed and a second catalyst bed, the second catalyst bed being downstream from the first catalyst bed during operation of the reactor; and a mixing device located between the first catalyst bed and the second catalyst bed, the mixing device comprising a plurality blades attached to a central hub, the blades being oriented at an angle of from about 15′ to about 75° relative to a reference axis of the mixing device, a cross sectional area of the mixing device being at least about 85% of a cross sectional area of the reactor, wherein a height of the mixing device is about 0.25 times to about 1.0 times a height of a blade, such as 0.4 times the height of a blade.

### BRIEF DESCRIPTION OF THE DRAWINGS

FIG. 1 schematically shows an example of a reactor configuration including a mixing device located between fixed beds of catalyst.

FIG. 2 schematically shows an example of a mixing device.

FIG. 3 schematically shows an alternate view angle for a mixing device.

### DETAILED DESCRIPTION

In various aspects, a stator-type mixing device is used as a mixing device between fixed catalyst beds in a reactor. The mixing device includes a plurality of blades or surfaces arranged around a central hub. The blades are arranged at an angle relative to vertical so that a fluid cannot pass vertically through the mixing device without contacting at least one blade or surface. The blades or surfaces allow the stator-type mixing device to span the full cross-sectional surface area of the reactor, so that concentration of liquids in a localized portion of the reactor cross-sectional area is reduced or minimized. It is noted that the mixing device is not a true stator, as there is not a corresponding rotor portion that revolves around an axis. For reactors where at least part of the process fluid is a liquid under reaction conditions, a distributor tray can be included below or downstream from the stator-type mixing device.

Fixed bed reactors are among the most common reactors in the chemical and refining industry. Fixed bed reactors can have one or more catalyst beds, and are usually operated in either a single vapor or liquid phase mode, or in a two phase mode (gas-liquid phase). Single phase reactors can be operated upflow or downflow. Two phase reactors are most commonly operated in cocurrent downflow mode, but countercurrent operation or cocurrent upflow can also be found. For cocurrent two phase downflow operation, a distributor tray is typically installed in the top of the reactor. In case of reactors having two or more beds, re-distribution is typically performed before entering each bed. For some applications, such as highly exothermic reactions, quench injection may also be beneficial. If this is the case, mixing internals can be provided in order to achieve homogeneous temperatures across the reactor cross sectional area. Even without quench injection, mixing internals can have significant benefits. Downstream from the mixing assembly, a distributor tray can be installed to provide uniform flow of vapor and liquid to the next catalyst bed.

Many different conventional mixing assembly designs have been proposed. These typically consist of two or more tray decks that contain features that create pressure drop and swirling flow. While the mixing performance of many such designs may be good, the designs typically have a number of shortcomings in common. For instance, significant reactor straight side (i.e., vertical height) is usually required, pressure drop is usually high, and the resulting liquid portion of the outlet flow is usually concentrated in a relatively small portion of the cross sectional area of the reactor. Additionally, the design features for conventional mixing assemblies can be complicated and difficult to build. The assemblies are also usually difficult to access for cleaning, inspection and repair, leading to significant time consumption during a reactor turnaround or catalyst changeout.

Still another potential shortcoming of traditional mixing assemblies is related to installation of a mixing assembly into an existing reactor. Some existing reactors may be able to benefit from installation of a mixing assembly even though the reactor did not originally include such mixing internals. This can be due to use of an older reactor design, addition of a new catalyst bed to the reactor (such as by dividing the space above an original catalyst bed into two separate spaces for holding catalyst), or for other reasons. For retrofit situations where a mixing assembly is added to an existing reactor, conventional mixing assemblies can present a variety of challenges. For example, the amount of vertical height available within the reactor for installation of the mixing assembly may be limited, resulting in insufficient space for installation of the mixing assembly. Additionally, welding of new reactor internals to the interior reactor walls may be undesirable for a variety of reasons. Many conventional mixing assemblies cannot be properly supported within a reactor unless some type of welding is performed to secure the assembly and/or a support ring for the assembly.

To overcome at least some of the above difficulties, a novel mixing device is described herein that can be installed between catalyst beds of fixed bed reactors. The design of this device has some similarity to a stator that is used in gas turbines and in jet engines. However, the rotor stage that would typically accompany a stator in a gas turbine or jet engine is not present. In aspects where the fixed catalyst beds are used in single vapor-phase reactors, no other reactor internals are required between the catalyst beds. In aspects where at least a portion of the fluid is in the liquid phase, a distributor tray can be located below the stator-type mixing device.

In various aspects, a stator-type mixing device that contains a plurality of angled blades can be used to improve mixing and distribution of fluids between catalyst beds. The catalyst beds on either side of the mixing device can conveniently be referred to as an upstream catalyst bed and a downstream catalyst bed, based on the direction of (co-current) fluid flow from the reactor inlet(s) for fluid to the reactor outlet(s) for fluid in a reactor containing the catalyst beds and the mixing device. The angled blades can allow the mixing device to generate a steady and relatively uniform swirling flow in a fluid passing through the mixing device. The swirling flow can be generated across substantially the entire cross sectional area of the reactor. Passing a fluid through the mixing device provides several mechanisms that can enhance liquid mixing, vapor mixing, liquid drop size reduction, and vapor-liquid heat and mass transport. For example, in a two phase reactor, process liquid exiting from the bottom of a catalyst bed can exit as droplets of various sizes. Droplets that are sufficiently small may be entrained in the gas flow, and therefore will be mixed based on the mixing of the gas flow. Larger droplets of the process liquid that cannot follow the gas phase flow will contact a blade or surface of the mixing device. Upon impact with a blade, a droplet can break up into smaller droplets that are more easily entrained in a gas flow, thus enhancing vapor-liquid mass transport.

With regard to mixing, the swirling flow generated by fluids passing through the space between the angled blades of the mixing device provides a turbulent phase interaction that is suitable for mixing hot and cold vapor and liquid streams. As is the case in various types of mixing devices, most of the mixing and mass transport occurs during swirl generation. For the mixing device described herein, a majority of the mixing occurs between the blades of the mixing device. The stator-type mixing device can preferably utilizes a single tray deck. The volume between the mixing device and a distributor tray (for two phase applications), or between the mixing device and a downstream catalyst bed (for single gas phase applications) can be utilized as mixing volume to further improve mixing and mass transport.

One advantage of a stator-type mixing device as described herein is that it utilizes substantially the entire cross sectional area of the reactor for flow. In various aspects, the cross sectional area of the mixing device can be at least about 85% of the cross sectional area of the reactor, such as at least about 90%, or at least about 95%. Preferably, any differences in the cross sectional area of the mixing device relative to the cross sectional area of the reactor can be due to vertical support structures present within the reactor. It is noted that the central hub or ring of the mixing device is included in the cross sectional area of the device, unless a support pipe or other support structure passes through the central ring. In traditional mixing assembly designs, at least the liquid portion of the flow from the previous catalyst bed is concentrated into a relatively small cross sectional area. Forcing all of the liquid into a small cross sectional area can improve liquid mixing, but additional work is then required to distribute the mixed liquid across the subsequent catalyst bed. As a result, such traditional mixing assembly designs require further hardware designed to mitigate the impact of the concentration of liquid prior to passing the liquid to the distributor tray or the next catalyst bed. This flow contraction and expansion in traditional designs requires additional hardware and thus increased time during catalyst changeout or turnaround; increased consumption of reactor straight side within the reactor; and increased pressure drop.

Another advantage of a stator-type mixing device as described herein is that the mixing device provides a relatively large open area for flow between blades. As a result, the mixing device has a reduced or minimized likelihood of accumulating foulant materials (such as dust or coke particles). In a conventional multi-deck mixing device, foulant materials can accumulate within a mixing chamber, leading to restriction of outflow of a conventional mixing device at some locations. This can reduce the effectiveness of such conventional mixing devices for generating an evenly distributed output flow.

In some aspects, the stator-type mixing device can occupy a reduced or minimized amount of reactor straight side between two fixed catalyst beds. Preferably, the stator-type mixing device can have a minimum number of tray decks, such as a single tray deck. Additionally or alternately, in some aspects the mixing device can facilitate opening and/or removal of the mixing during turnarounds or catalyst changeouts. The mixing device can also provide a desirable amount of vapor and liquid mixing performance; a desirable amount of vapor-liquid mass transport; and a desirable (relatively even or uniform) distribution of vapor and liquid flow across the reactor cross-sectional area. Preferably, one or more of these desirable mixing and distribution features can be achieved for the fluids exiting the mixing device while reducing or minimizing the amount of pressure drop across the mixing device.

In this discussion, a “catalyst bed” refers to the support structure for supporting catalyst loaded into a reactor at a given height within a reactor. Any catalyst supported within a catalyst bed will be referred to separately.

In this discussion, reference will be made to an axis perpendicular to the central hub or ring of the mixing device. In general, the mixing device described herein will have a substantially symmetric design, so that rotation of the mixing device around an appropriate axis will result in a number of repeating configurations that have substantially the same characteristics. For example, consider a mixing device having “n” blades. If the mixing device is rotated around an appropriate axis by a number of degrees that is equal to an integer multiple of 360/n, the resulting position of the mixing device should have a substantially equivalent appearance. This axis of rotation for the mixing device will generally correspond to an axis that is perpendicular to a plane defined by the central hub or annular ring of the mixing device and/or a plane of the mixing device. This axis is defined herein as the reference axis for the mixing device. It is noted that the mixing device does not rotate within the reactor. Instead, rotation of the mixing device is used to conceptually describe the desired reference axis.

In many situations, the mixing device will be installed in a co-current, downflow reactor so that the direction of gravitational pull is substantially aligned with the reference. In such situations, the reference axis will also correspond to a vertical axis. For convenience, this discussion may alternatively refer to the vertical axis when describing the axis perpendicular to the central hub or ring (the reference axis). However, alignment between the reference axis and the direction of gravitational pull is not required for use of the mixing device.

### Stator-Type Mixing Device

A stator-type mixing device can include a central hub/annular ring/central support pipe structure and a plurality of blades or other wall-like structures that provide a surface. The plurality of blades can be supported by the central hub or ring, by connection to the reactor wall, by connection to an outer support ring that is supported by the reactor wall, or a combination thereof. It is noted that if a central support pipe or other support structure is present, such a support pipe or support structure can supplement or even eliminate the need to attach the blades to the reactor wall or to a support ring/other support structure located at the reactor wall. Optionally, additional support rings having a radius that is intermediate to the radius of the central hub or ring and the reactor wall can also be used to provide additional structural integrity for the mixing device.

When a central support pipe is not used, the central hub or annular support ring provides structural integrity for the mixing device. The hub or support ring is preferably capped so that fluids cannot pass through the center of the mixing device. Instead, the center of the mixing device represents a location where outward radial motion of fluids is needed for the fluids to pass through the mixing device. This is in contrast to the blades, where an angular or rotational motion allows fluids to move between the blades and through the mixing device. The size of the central hub or support ring can be any convenient size that allows the hub to provide sufficient structural stability for the mixing device. The size can be dependent on the diameter of the mixing device (which roughly corresponds to the diameter of the reactor), For example, the diameter of the central hub can be about 5% to about 15% of the diameter of the mixing device, such as at least about 8%, or about 12% or less, or about 10% or less.

The blades of the mixing device can have a length corresponding to the distance from the edge of the central hub to either the reactor wall or to an outer support ring, such as an outer support ring that is attached to the reactor wall. Optionally but preferably, all of the fluid emerging from a catalyst bed above the mixing device passes through one of the gaps between the blades, as opposed to allowing fluid to pass through the central hub or around the edge of the mixing device. The blades can have any convenient thickness that is suitable for providing structural integrity for the mixing device. The blade thickness is not critical, so long as the gaps between the blades are large relative to the blade thickness.

The blades of the mixing device can have any convenient shape. One possible shape for the blades is to have blade that have the same height along the length of the blade, so that the height of the blade at the central hub is the same as the height at the outer edge of the mixing device. Such a blade can correspond to a planar blade surface. Another option is to have blades that, when viewed along the reference axis, sweep out a constant angular portion of the reactor along the length of the blade. It is noted that this second option for the blade shape will result in a curved blade surface. For any of the various potential blade shapes, the height of the blades can be characterized based on the blade height at the outer edge of the mixing device.

The height of the blades can be selected so that the blades form channels to create a rotational motion for at least gases that pass through the mixing device. Because the blades are positioned at an angle relative to the reference axis, when viewed from above along the reference axis, a lower portion of each blade will be obstructed from view by at least an upper portion of an adjacent blade. The amount of surface area of a blade that is obstructed by an adjacent blade when viewed along the reference axis can be referred to as an overlap of the blades. The amount of overlap for the blades can be characterized based on the amount of surface area for each blade that is obstructed from view when the mixing device is viewed along the reference axis. In various aspects, each blade can have at least about 25% of surface area overlap with the adjacent blade, such as at least about 40% surface area overlap, or at least about 50% overlap. Additionally or alternately, the amount of surface area overlap between adjacent blades can be about 70% or less, such as about 60% or less. It is noted that each blade has two adjacent blades. Thus, each blade will have a lower portion overlapped by an adjacent blade on one side, while an upper portion of the blade will overlap with the adjacent blade on the other side.

The height of the blades can also be dependent on the angle of the blades relative to vertical. In various aspects, the angle of the blades can be from about 15° to about 75° relative to vertical. For example, the angle of the blades can be at least about 20°, such as at least about 30′, or at least about 45°. Additionally or alternately, the angle of the blades can be about 75° or less, such as about 60° or less. Larger angles relative to vertical can assist with inducing larger amounts of rotational motion into a fluid flow. Preferably, all of the blades of a mixing device can have a similar angle relative to the reference axis (usually relative to vertical), such as having the angle relative to the reference axis of each blade differing by about 5° or less relative to each adjacent blade, and preferably differing by about 3° or less or about 1° or less.

The number of blades can be any convenient number. One way of characterizing the number of blades can be based on the angular portion of the cross sectional area where the surface of a blade is exposed at the outer edge of the mixing device when viewed along the reference axis. When viewed along the reference axis, the exposed surface area for each blade can correspond to about 30° or less of the cross sectional area of the reactor (at least 12 blades), such as about 24° or less (at least 15 blades), or about 20° or less (at least 18 blades). Additionally or alternately, the exposed surface area for each blade can correspond to at least about 6° of the cross sectional area (60 blades or less), such as at least about 8° (45 blades or less) or at least about 10° (36 blades or less). In terms of the angular portion of cross sectional area, the thickness of each blade can correspond to 1° or less of cross sectional area.

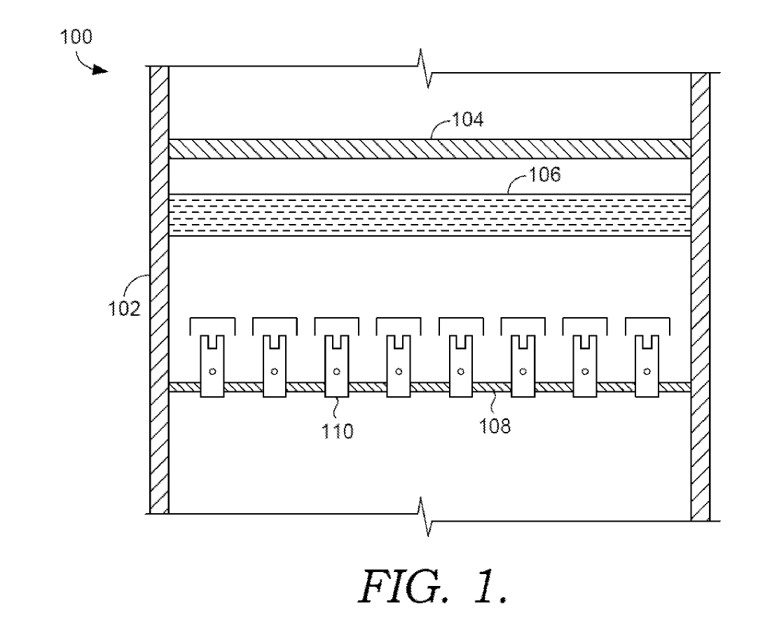

FIG. 1 shows an example of a mixing device that is installed between catalyst beds in a fixed bed reactor 100 designed for cocurrent downflow of vapor and liquid. (Of course, in other aspects, the configuration shown in FIG. 1 could also be used for processing of just gas phase or just liquid phase flows.) The various tray decks, discussed in detail below, can conveniently be supported from the reactor shell 102, from a central support structure or pipe, or a combination thereof. In FIG. 1, catalyst can be loaded on top of the catalyst support structure 104, which can also be referred to as a catalyst bed. During operation, liquid surrounded by the flowing vapor phase can rain down from the catalyst support structure 104 onto the mixing device 106. Fluids exiting from the mixing device 106 impinge on the distributor tray 108 below. The distributor tray 108 shown in FIG. 1 corresponds to a chimney downcomer type design in which vapor enters the individual downcomer pipes 110 from the top, and liquid enters each pipe through one or more holes drilled into the side of the pipe. The liquid holdup on the distributor tray 1 08 experiences swirling motion generated by the stator-type mixing device 106, thus enhancing mixing in the liquid phase. Additionally or alternately, any other type of distributor tray that provides some liquid holdup on the tray, e.g. a bubble cap tray, can be utilized in combination with the current invention.

In single vapor phase operation of a fixed bed reactor, distributor trays are often not installed. If such a single-phase reactor has two or more catalyst beds, necessitated for instance by large temperature rise along the catalyst bed, the new stator-type mixing device can be installed for temperature homogenization between the catalyst beds without requiring a distributor tray after the mixing device. Instead, the fluids exiting from the mixing device can impinge directly on the next catalyst bed.

In addition to the structures shown in FIG. 1, the reactor can also include an apparatus for delivering quench fluids to the space between the bottom of the upper catalyst bed and the mixing device. For example, a quench ring having a plurality of openings for injecting a quench fluid (liquid and/or gas) can be used to deliver a quench fluid. Other types of structures for delivering a quench fluid, such as nozzles, can be used instead of or in addition to a quench ring.

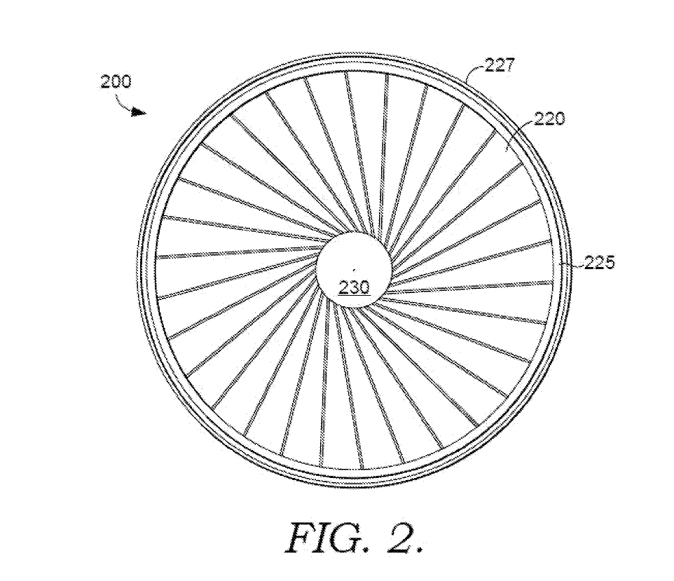

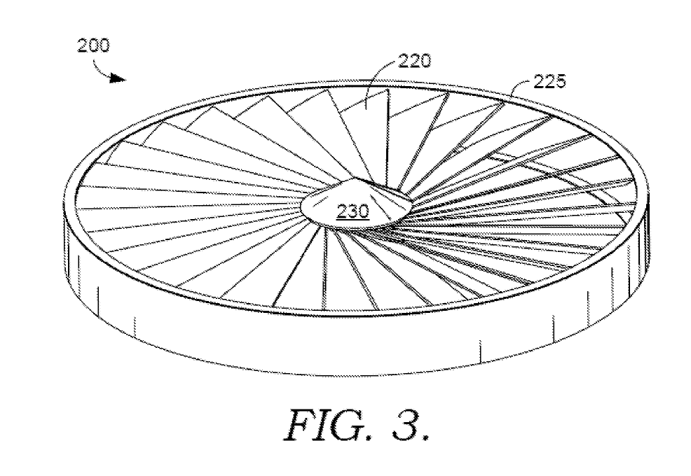

FIGS. 2 and 3 schematically show views of a mixing device 200 in more detail. FIG. 2 shows a view of mixing device 200 along the reference axis, while FIG. 3 corresponds to a perspective view. The blades 220 of the mixing device are supported in the desired blade angle by frame 225, and a ring located underneath the center plenum 230. Frame 225 can be supported for instance by a support ring attached to the vessel wall 227. The center plenum 230 shown in FIGS. 2 and 3 serves as a cover above the center support ring.

The liquid raining down from the catalyst bed above will see a solid surface, as shown in FIG. 2. Smaller droplets will be generated upon impact of the liquid drops on the blades 220 shown in FIGS. 2 and 3. The increased number of smaller size droplets increases the total liquid surface area, improving vapor-liquid heat and mass transfer. Due to the angled blade orientation, a swirling flow will be generated by the flowing vapor stream above and below the mixing stator. Due to this swirling flow, differences in temperature or concentration in the vapor phase, will be reduced towards uniformity. In addition, the swirling gas flow will carry the small liquid droplets generated upon impact on the stator blades with it in its swirling motion, thereby spreading out the liquid droplets of possibly different temperature or concentration. As a result, a hot spot in form of a liquid stream several inches in diameter that would rain down from the catalyst bed above will be spread out into more droplets that are carried into various directions and at various distances from the original point of impact on the blades. During this transport of the liquid droplets in the vapor stream, vapor and liquid will also bring their temperatures and concentrations towards equilibrium. Further reduction of temperature and concentration differences in the liquid phase will occur on the distributor tray. The swirling flow generated by the mixing stator will also lead to some swirling motion of the liquid holdup that is established on the distributor tray. The liquid droplets raining down onto the distributor tray will thus further dilute their temperature and concentrations with the liquid holdup on the distributor tray.

Upon removal of the plenum 230, the area inside the center support ring can be utilized as manway for easy access towards the bottom of the reactor. Design modifications can be built that allow adaptation of the mixing device to various unconventional or novel reactors. For instance, this mixing device can be combined with a center pipe support structure where the center ring of the mixing device would be partially or entirely supported from the center pipe. In this design modification, manway access can be provided by a number of easily removable blades 220. If the reactor diameter is large, the mixing blades can be split into two or more sections held in place by additional concentric support rings between the center plenum and the vessel wall.

### Path Lengths For Fluid Flow Through the Mixing Device

A mixing device as described herein can provide a number of advantages relative to conventional mixing devices. In some aspects, the mixing device can provide suitable mixing fbr fluids between catalyst beds with a reduced or minimized pressure drop. Additionally or alternately, the reduced number of decks or platforms required for the mixing device, combined with the presence of a central hub, results in a mixing device that can readily provide access to the volume below the mixing device during catalyst changeouts or other reactor turnaround events.

Both of the above advantages are related in part to the path length for fluids to pass through the mixing device. With regard to the height of the mixing device, the height of a mixing device is defined herein as a distance or height along the reference (usually vertical) axis. The height of a mixing device begins at the first location after exiting the bottom of a catalyst bed support structure where fluids enter a physical structure that substantially modifies the flow path of the fluids. Structures primarily used for introducing a quenching flow of gas or liquids are specifically excluded from this definition, unless such structures also provide a structural modification of the flow, such as acting as a liquid holdup tray or serving as the entry point for conduits through a mixing device structure. The height of a mixing device ends when the fluids exit the bottom of a structure and then the next structure encountered by the fluids in the reactor is either a catalyst bed or a distributor tray. It is noted that based on the above definition, the height of a mixing device within a reactor can include multiple trays of mixing structures, as well as any open space located between such multiple structures. However, the mixing device described herein will typically include only one tray.

Based on the above definitions, the height of the mixing device described herein will correspond to at least the distance from the top of a blade to the bottom of a blade along the reference (usually vertical) axis. If the top of the central hub or ring is located above the top of the blades, that location can correspond to the top of the mixing device. However, extensions from the central hub and/or an outer support ring that primarily serve to improve the structural support of the mixing device are not considered in determining the height of the mixing device, as such structures have a minimal impact on the flow of fluids through the device. In various aspects, the height of a mixing device can be at least about 1.0 ft, such as at least about 1.5 ft, or at least about 2.0 ft, or at least about 3.0 ft. Additionally or alternately, the height of the mixing device can be about 8.0 ft or less, such as about 6.0 ft or less, or about 5.0 ft or less, or about 4.0 ft or less. The desired height of the mixing device can vary depending on a variety of factors, such as the diameter and/or cross sectional area of the reactor, the (expected) flow rate of fluids through the mixing device, or a combination thereof.

Based on the definition of the height of a mixing device, a path length for fluids passing through a mixing device can also be defined. For a given a cross sectional location where a fluid can enter into (including impinge on) a mixing device, the path length is defined herein as the minimum distance a fluid must travel to exit from the mixing device. For any mixing device, a plurality of path lengths through the device will exist. The plurality of path lengths reflect the fact that fluids exiting from the bottom of a catalyst bed will exit at locations corresponding to substantially the entire cross section of the catalyst bed. If vertical support structures are present within the reactor volume, a few locations within the cross section may be excluded as potential locations for exiting the catalyst bed, but otherwise any location in the cross sectional area is generally a potential exit location from an upper catalyst bed. Similarly, any location in the cross sectional area that is not otherwise excluded by an internal reactor structure is a potential entry location for the mixing device. Based on the definition of a height of a mixing device, the minimum path length possible through a mixing device is the height. However, most (if not all) path lengths through an actual mixing device will be greater than the height of the mixing device.

Because the path length for a fluid through a mixing device can vary depending on the entry location for the fluid in the cross sectional area, a maximum path length can also be defined for a mixing device. The maximum path length for a mixing device is defined herein as the maximum path length for a fluid to pass through a mixing device based on the path length definition above. For example, some mixing devices are designed to force all liquids passing through the mixing device to accumulate in a central mixing chamber. For liquids that enter the mixing device near the edge of the reactor, the liquids must travel from the edge of the reactor to the central mixing chamber. This increases the path length for such liquids, so an edge location in the cross-sectional area will likely have the maximum path length for the mixing device.

An advantage of the mixing device described herein is that the minimum path length for the mixing device, as well as the path length for most cross sectional locations of the mixing device, is only modestly greater than the height of the mixing device. Additionally, the maximum path length for the mixing device corresponds roughly to the height of the blades plus the height of the mixing device. Therefore, the maximum path length is at least partially related to the height of the mixing device.

The minimum path length for a mixing device is defined as the shortest path length for a fluid to pass through the mixing device for at least one cross sectional location. As noted above, the smallest possible value for the minimum path length is a path length that is equal to the height of the mixing device. In various aspects, the ratio of minimum path length for the mixing device to the height of the mixing device can be about 3.0:1 or less, such as about 2.5:1 or less, or about 2.0:1 or less.

The maximum path length for a mixing device is defined as the longest path length for a fluid to pass through the mixing device for at least one cross sectional location. For conventional mixing devices, the maximum path length will often be related to the diameter of the device, as fluid entering the mixing device near the edge of the mixing device is required to travel inward to a central mixing chamber. By contrast, the maximum path length for the mixing device described herein is related to the height of the mixing device, the length of a blade, and/or the size of the inner hub.

In some preferred aspects, the maximum path length can correspond to the height of a blade, which is defined as corresponding to the height of the blade surface at the outer circumference of the mixing device. Optionally, if a portion of the mixing device extends above or below the blade, the maximum path length could be longer than the blade height, but always less than the sum of the blade height plus the height of the mixing device, which would correspond to the limiting case of a blade oriented at 90° (perpendicular to the reference axis). In various aspects, the height of a blade can be at least about 0.5 ft, such as at least about 1.0 ft, or at least about 2.0 ft, or at least about 2.5 ft. Additionally or alternately, the height of a blade can be about 10 ft or less, such as about 8.0 ft or less, or about 7.0 ft or less, or about 6.0 ft or less, or about 5.0 ft or less, or about 4.0 ft or less.

Another way of defining the height of a blade is based on the height of the mixing device. As a limiting case, because the blades are oriented at an angle within the mixing device, the height of the mixing device can be less than the height of a blade. In various aspects, the height of the mixing device can be at least about 0.25 times the height of a blade, such as at least about 0.4 times the height of a blade, or at least about 0.5 times the height of a blade. Additionally or alternately, the height of the mixing device can be 0.97 times the height of a blade or less, such as 0.9 times the height of a blade or less.

In aspects where the height of the blade is the same at central hub and at the outer edge of the device, the maximum path length can correspond to the height of the blade plus the diameter of the hub or central ring. This maximum path length corresponds to fluids which impinge on the center of the mixing device, which then travel radially outward to where the blades contact the central hub.

### Examples of Processing Conditions and Catalysts

It is believed herein that these methods of invention herein are particularly beneficial in improving reactor catalyst bed flow distributions in two-phase fixed bed reactor vessels. In a two-phase reactor process, the feedstream is a mixture of at least one gas phase component and at least one liquid phase component. Such flowstreams/feedstreams are typical in large hydroprocessing reactors used in the processing of base and intermediate stock hydrocarbon feedstreams in petroleum and petrochemical refineries. These processes include: hydrotreating, hydrodesulfurization, hydrodenitrogenation, hydrodemetalation, hydrogenation, hydroisomerization, hydrocracking, aromatic saturation, olefin saturation processes, and other fixed bed technologies used in chemical reactors. In the processes listed above, a hydrocarbon based liquid feedstream is mixed with a hydrogen containing gas stream and then exposed to the catalyst in the reactor vessel to produce an improved product slate. Typically such processes are useful in removing sulfur and other contaminants from hydrocarbon feedstreams (e.g., hydrodesulfurization, hydrodenitrogenation, or hydrodemetalation processes), reducing the average boiling point of hydrocarbon feedstreams (e.g., hydrocracking processes), and/or modifying the hydrocarbon compounds in the hydrocarbon feedstreams (e.g., hydrogenation or hydroisomerization processes). Other processes not involving hydrogen treatment may also be used, such as synthesis reactions for making various chemical products. Still another possible process is naphtha reforming. In each of these processes, specific types of catalysts will be utilized depending upon the feedstream composition and the product compositions to be sought.

Preferred hydroprocessing operating conditions for reactor vessels targeted by the methods of invention herein include two-phase flow including one or more of the following conditions: a temperature of at least about 260° C., for example at least about 300° C.; a temperature of about 425° C. or less, fbr example about 400° C. or less or about 350° C. or less; a liquid hourly space velocity (LHSV) of at least about 0.1 hr⁻¹, for example at least about 0.3 hr⁻¹, at least about 0.5 hr⁻¹, or at least about 1.0 hr⁻¹; an LHSV of about 10.0 hr⁻¹ or less, for example about 5.0 hr⁻¹ or less or about 2.5 hr⁻¹ or less; a hydrogen partial pressure in the reactor of at least about 100 psig (about 0.7 MPag), such as from about 200 psig (about 1.4 MPag) to about 3000 psig (about 20.7 MPag), for example about 400 psig (about 2.8 MPag) to about 2000 psig (about 13.8 MPag); a hydrogen to feed ratio (hydrogen treat gas rate) from about 500 scf/bbl (about 85 Nm³/m³) to about 10,000 scf/bbl (about 1700 Nm³/m³), for example from about 1000 Scf/bbl (about 170 Nm³/m³) to about 5000 scf/bbl (about 850 Nm³/m³).

The mixing device described herein can be incorporated into any convenient reactor containing two or more fixed catalyst beds. The fixed catalyst beds can include catalysts for hydroprocessing, chemical synthesis, or any other convenient type of catalyst that is conventionally used in a fixed bed catalyst. As an example, the mixing device described herein can be used in a hydroprocessing reactor containing two or more catalyst beds. A first hydroprocessing catalyst can be loaded in the catalyst bed below the mixing device, while a second hydroprocessing catalyst can be loaded in the catalyst bed above the mixing device. The first and second hydroprocessing catalysts can be the same or different. Optionally, the first and second hydroprocessing catalysts can be catalyst systems, comprising a series of catalysts stacked on top of one another. The first and second hydroprocessing catalysts can be selected from any convenient catalyst or catalyst system for hydrotreatment, hydrocracking, catalytic dewaxing, hydrofinishing, or other hydroprocessing functions.

In various embodiments, a suitable catalyst fbr hydrotreatment, hydrocracking, catalytic dewaxing, aromatic saturation, and/or hdrofinishing can be a catalyst composed of one or more Group VIII and/or Group VI metals. The catalyst can correspond to a bulk catalyst, or the Group VIII and/or Group VI metals can be supported on a metal oxide support. Suitable metal oxide supports can include low acidic oxides such as silica, alumina, silica-aluminas or titania. The supported metals can include Co, Ni, Fe, Mo, W, Pt, Pd, Rh, Ir, or a combination thereof. In an embodiment, the supported metal can be Pt, Pd, or a combination thereof. In another embodiment, the supported metal can be one or more of Co, Ni, Mo, and W, such as CoMo, NiW, or NiMoW. The amount of metals, either individually or in mixtures, can range from about 0.1 to about 35 wt. %, based on the catalyst. In an embodiment, the amount of metals, either individually or in mixtures, can be at least about 0.1 wt %, or at least about 0.25 wt %, or at least about 0.5 wt %, or at least about 0.6 wt %, or at least about 0.75 wt %, or at least about 1 wt %. In another embodiment, the amount of metals, either individually or in mixtures, can be about 35 wt % or less, or about 20 wt % or less, or about 15 wt % or less, or about 10 wt % or less, or about 5 wt % or less. In embodiments wherein the supported metal is a noble metal, the amount of metals is typically less than about 2 wt %, or less than about 1 wt %. In such embodiments, the amount of metals can be about 0.9 wt % or less, or about 0.75 wt % or less, or about 0.6 wt % or less. The amounts of metals may be measured by methods specified by ASTM for individual metals including atomic absorption spectroscopy or inductively coupled plasma-atomic emission spectrometry. In some embodiments, the catalyst can be catalyst with a relatively lower level of hydrogenation activity, such as a catalyst containing Co as a Group VIII metal, as opposed to a catalyst containing Ni, Pt, or Pd as a Group VIII metal. In an alternative embodiment, at least a portion of one or more catalyst beds or stages can include a catalyst that further comprises a zeolite or other molecular sieve. Such catalysts comprising molecular sieves can have beneficial activity for hydrocracking and dewaxing type reactions.

### Additional Embodiments

### Embodiment 1

A reactor for exposing a reaction fluid to catalyst in a plurality of fixed catalyst beds, comprising: at least one reactor inlet and at least one reactor outlet; a first catalyst bed and a second catalyst bed, the second catalyst bed being downstream from the first catalyst bed during operation of the reactor; and a mixing device located between the first catalyst bed and the second catalyst bed, the mixing device comprising a plurality blades attached to a central hub, the blades being oriented at an angle of from about 15° to about 75° relative to a reference axis of the mixing device, a cross sectional area of the mixing device being at least about 85% of a cross sectional area of the reactor, wherein a ratio of a minimum path length for the mixing device to the height of the mixing device is about 4.0:1 or less.

### Embodiment 2

A reactor for exposing a reaction fluid to catalyst in a fixed catalyst bed, comprising: at least one reactor inlet and at least one reactor outlet; a catalyst bed; and a mixing device located upstream from the catalyst bed, the mixing device comprising a plurality blades attached to a central hub, the blades being oriented at an angle of from about 15° to about 75° relative to a reference axis of the mixing device, a cross sectional area of the mixing device being at least about 85% of a cross sectional area of the reactor, wherein a height of the mixing device is about 0.25 times to about 1.0 times a height of a blade, such as 0.4 times the height of a blade.

### Embodiment 3

The reactor of Embodiment 2, further comprising an additional catalyst bed, the additional catalyst bed being upstream from the mixing device during operation of the reactor.

### Embodiment 4

A reactor for exposing a reaction fluid to catalyst in a plurality of fixed catalyst beds, comprising: at least one reactor inlet and at least one reactor outlet; a first catalyst bed and a second catalyst bed, the second catalyst bed being downstream from the first catalyst bed during operation of the reactor; and a mixing device located between the first catalyst bed and the second catalyst bed, the mixing device comprising a plurality blades attached to a central hub, the blades being oriented at an angle of from about 15° to about 75° relative to a reference axis of the mixing device, a cross sectional area of the mixing device being at least about 85% of a cross sectional area of the reactor, wherein a height of the mixing device is about 0.25 times to about 1.0 times a height of a blade, such as 0.4 times the height of a blade

### Embodiment 5

The reactor of any of the above Embodiments, wherein the ratio of the minimum path length to the height of the mixing device is about 4.0 or less, such as about 3.0 or less, or about 2.5 or less.

### Embodiment 6

The reactor of any of the above Embodiments, wherein the angle of the blades relative to the reference axis is about 60° or less and/or at least about 30°.

### Embodiment 7

The reactor of any of the above Embodiments, further comprising a distributor tray located between the mixing device and the second (downstream) catalyst bed.

### Embodiment 8

The reactor of any of the above Embodiments, wherein a maximum path length of the mixing device is less than a combined value of the height of a blade and a radius of the central hub.

### Embodiment 9

The reactor of any of the above Embodiments, wherein the central hub comprises an annular hub.

### Embodiment 10

The reactor of any of the above Embodiments, further comprising one or more openings for injecting a quench fluid between the first (upstream) catalyst bed and the mixing device.

### Embodiment 11

The reactor of any of the above Embodiments, wherein for each blade of the plurality of blades, an angle of a first blade is different from an angle of an adjacent blade by about 3° or less, such as by about 1° or less.

### Embodiment 12

The reactor of any of the above Embodiments, wherein the plurality of blades comprises from 12 to 36 blades, such as at least 15 blades, or at least 18 blades, or 30 blades or less.

### Embodiment 13

The reactor of any of the above Embodiments, wherein the mixing device further comprises an external support ring, the external support ring being attached to the plurality of blades and being in contact with an interior surface of th reactor.

### Embodiment 14

The reactor of Embodiment 13, wherein the mixing device further comprises a second support ring located between the external support ring and the central hub.

When numerical lower limits and numerical upper limits are listed herein, ranges from any lower limit to any upper limit are contemplated. While the illustrative embodiments of the invention have been described with particularity, it will be understood that various other modifications will be apparent to and can be readily made by those skilled in the art without departing from the spirit and scope of the invention. Accordingly, it is not intended that the scope of the claims appended hereto be limited to the examples and descriptions set forth herein but rather that the claims be construed as encompassing all the features of patentable novelty which reside in the present invention, including all features which would be treated as equivalents thereof by those skilled in the art to which the invention pertains.

The present invention has been described above with reference to numerous embodiments. Many variations will suggest themselves to those skilled in this art in light of the above detailed description. All such obvious variations are within the full intended scope of the appended claims.

What is claimed is:

1. A reactor for exposing a reaction fluid to catalyst in a plurality of fixed. catalyst beds, comprising:
at least one reactor inlet and at least one reactor outlet;
a first catalyst bed and a second catalyst bed, the second catalyst bed being downstream from the first catalyst bed during operation of the reactor; and
a mixing device located between the first catalyst bed and the second catalyst bed, the mixing device comprising a plurality blades attached to a central hub, the blades being oriented at an angle of from about 15° to about 75° relative to a reference axis of the mixing device, a cross sectional area of the mixing device being at least about 85% of a cross sectional area of the reactor,
wherein a ratio of a minimum path length for the mixing device to the height of the mixing device is about 4.0:1 or less.

2. The reactor of claim 1, wherein the ratio of the minimum path length to the height of the mixing device is about 3.0 or less.

3. The reactor of claim 1, wherein the angle of the blades relative to the reference axis is about 60° or less.

4. The reactor of claim 1, further comprising a distributor tray located. between the mixing device and the second catalyst bed.

5. The reactor of claim 1, wherein a maximum path length of the mixing device is less than a combined value of the height of a blade and a radius of the central hub.

6. The reactor of claim 1, wherein the central hub comprises an annular hub.

7. The reactor of claim 1, further comprising one or more openings for injecting a quench fluid between the first catalyst bed and the mixing device.

8. The reactor of claim 1, wherein for each blade of the plurality of blades, an angle of a first blade is different from an angle of an adjacent blade by 3° or less.

9. The reactor of claim 1, wherein the plurality of blades comprises from 12 to 36 blades.

10. The reactor of claim 1, wherein the mixing device further comprises an external support ring, the external support ring being attached to the plurality of blades and being in contact with an interior surface of the reactor.

11. The reactor of claim 10, wherein the mixing device further comprises a second support ring located between the external support ring and the central hub.

12. A reactor for exposing a reaction fluid to catalyst in a fixed catalyst bed, comprising:
at least one reactor inlet and at least one reactor outlet;
a catalyst bed; and
a mixing device located upstream from the catalyst bed, the mixing device comprising a plurality blades attached to a central hub, the blades being oriented at an angle of from about 15° to about 75° relative to a reference axis of the mixing device, a cross sectional area of the mixing device being at least about 85% of a cross sectional area of the reactor,
wherein a height of the mixing device is about 0.25 times to about 1.0 times a height of a blade.

13. The reactor of claim erein the angle of the blades relative to the reference axis is about 60° or less.

14. The reactor of claim 12, further comprising a distributor tray located between the mixing device and the catalyst bed.

15. The reactor of claim 12, further comprising an additional catalyst bed, the additional catalyst bed being upstream from the mixing device during operation of the reactor.

16. The reactor of claim 15, wherein a ratio of the minimum path length to the height of the mixing device is about 4.0 or less.

17. The reactor of claim 15, wherein a maximum path length of the mixing device is less than a combined value of the height of a blade and a radius of the central hub.

18. The reactor of claim 12, further comprising one or more openings for injecting a quench fluid between the first catalyst bed and the mixing device.

19. The reactor of claim 12, wherein the mixing device further comprises an external support ring, the external support ring being attached to the plurality of blades and being in contact with an interior surface of the reactor.

20. The reactor of claim 19, wherein the mixing device further comprises a. second support ring located between the external support ring and the central hub.
